(19) United States
(12) Patent Application Publication
(10) Pub. No.: US 2015/0262332 A1
(43) Pub. Date: Sep. 17, 2015

(54) IMAGE PROCESSING METHOD AND ELECTRONIC DEVICE SUPPORTING THE SAME

(71) Applicant: Samsung Electronics Co., Ltd., Gyeonggi-do (KR)

(72) Inventors: Sang Uk PARK, Gyeonggi-do (KR); Han Sang KIM, Seoul (KR); Yang Geun OH, Gyeonggi-do (KR); Jung Won LEE, Incheon (KR)

(21) Appl. No.: 14/656,815

(22) Filed: Mar. 13, 2015

(30) Foreign Application Priority Data
Mar. 13, 2014 (KR) 10-2014-0029864

(51) Int. Cl. G06T 3/40

(52) U.S. Cl. CPC G06T 3/40

(57) ABSTRACT

Presented herein is a method of processing an image. The method includes obtaining a scale ratio for an original image, obtaining coefficient information based on the scale ratio, applying data conversion and scaling of the original image base on using the coefficient information to at least some of the original image, and generating image processed data corresponding to the scale ratio.

### CROSS-REFERENCE TO RELATED APPLICATION

This application for a U.S. patent claims priority under 35 U.S.C. §119(a) to Korean Patent Application No. 10-2014-0029864 filed Mar. 13, 2014, the disclosure of which is hereby incorporated in its entirety by reference for all purposes.

### BACKGROUND

1. Field of the Invention

The present invention relates to image processing.

2. Background of the Invention

With the development of digital technology, many electronic devices are capable of communication and processing personal information on the move, such as mobile communication terminals, personal digital assistants (PDAs), electronic notes, smart phones, and tablet personal computers (PCs) have been recently released. These electronic devices are capable of performing image processing related to image display.

A typical electronic device uses an image processing technique that has either a high loss or places a high computational burden on the electronic device. However, an image processing technique having high loss may have a faster operation speed but result in a lower quality image. Also, an image processing technique that uses a high computational burden either consumes a large amount of hardware resources of a specific electronic device (e.g., a device having limited hardware, such as a mobile electronic device) or has a slow operation speed.

### SUMMARY

Accordingly, various embodiments are directed to providing an image processing method and an electronic device supporting the same that may improve both a processing speed and quality.

According to one embodiment, there is presented a method of processing an image. The method includes obtaining a scale ratio for an original image, obtaining coefficient information based on the scale ratio, applying data conversion and scaling of the original image based on using the coefficient information to at least some of the original image, and generating image processed data corresponding to the scale ratio.

According to another embodiment, there is presented an electronic device. The electronic device includes a data processing module, and at least one storage module. The data processing module is configured to check scale ratio information for an original image and to generate image processed data corresponding to the scale ratio. The data processing module generates image processed data corresponding scale ratio by applying coefficient information. The coefficient information is based on the scale ratio information. The data processing module applies the coefficient information during the data conversion and scaling of the original image to at least some data of the original image. The at least one storage module is configured to store the original image.

According to still another embodiment, there is presented a non-transitory machine-readable medium. The non-transitory machine-readable medium stores a plurality of commands. The plurality of commands, when being executed by at least one processor, cause the at least one processor to perform certain operations. These operations include obtaining scale ratio information for an original image, obtaining coefficient information based on the scale ratio information, applying data conversion and scaling of the original image using the coefficient information, and obtaining image processed data corresponding to the scale ratio based on applying the coefficient information to at least some data of the original image to obtain image processed data corresponding to the scale ratio.

Also, various embodiments provide an image processing method and an electronic device supporting the same that may provide a high operation speed and an image having certain quality when a fixed image scale ratio is applied.

Also, various embodiments provide an image processing method and an electronic device supporting the same that may provide a high operation speed and image data having various scales which a user desires.

### BRIEF DESCRIPTION OF THE DRAWINGS

FIG. 1 shows a device operating system according to various embodiments.

FIG. 2 is a block diagram of a data processing module of an electronic device according to various embodiments.

FIG. 3 shows image data conversion and scaling according to various embodiments.

FIG. 4 represents an image processing method according to various embodiments.

FIG. 5 represents an image scaling method according to various embodiments.

FIG. 6 is a table showing resolution and speed results for image processing according to various embodiments.

FIG. 7 is a block diagram of an electronic device according to various embodiments.

### DETAILED DESCRIPTION

Various embodiments of the present invention are described below in conjunction with the accompanying drawings.

Since various modifications can be made to the embodiments that are illustrated in the drawings and described in the detailed description, it should be understood that the present invention is not limited to any particular embodiments.

In describing the drawings, similar components are denoted through the use of similar reference numerals.

The expression “include” or “may include” that may be used in describing the embodiments of the present invention indicates the presence of a disclosed corresponding function, operation or component but does not exclude one or more functions, operations or components in addition. Furthermore, in describing the embodiments of the present invention, it should be understood that the term “includes” or “has” indicates the presence of characteristics, numbers, steps, operations, components, parts or combinations thereof represented in the present disclosure but does not exclude the presence or addition of one or more other characteristics, numbers, steps, operations, components, parts or combinations thereof.

In various embodiments of the present invention, the expression “or” or “at least one of A and/or B” includes any and all combinations of words enumerated along with the expression. For example, the expression “A or B” or “at least one of A and/or B” may include A, B, or both A and B.

The expression “a first”, “a second”, “firstly”, or “secondly” in the various embodiments of the present invention may modify various components of the various embodiments but does not limit corresponding components. For example, the expressions above do not limit the order and/or importance of corresponding components. The expressions above may be used to distinguish one component from another component. For example, both a first user device and a second user device are user devices that are mutually different user devices. For example, the first component may be named as the second component, and similarly, the second component may also be named as the first component.

When any component is referred to as being “connected” to or “accessed” by another component, it should be understood that the former can be “directly connected” to the latter, or there may be another component in between. On the contrary, when any component is referred to as being “directly connected” to or “directly accessed” by another component, it should be understood that there may be no other component in between.

The terms used in describing the various embodiments of the present invention are used only to describe specific embodiments and are not intended to limit the various embodiments of the present invention. The terms in singular form include the plural form unless otherwise specified.

Unless otherwise defined, all terms used herein including technical or scientific terms have the same meanings as those generally understood by a person or ordinary skill in the art. Terms defined in generally used dictionaries should be construed to have meanings matching contextual meanings in the related art and should not be construed as having an ideal or excessively formal meaning unless otherwise defined herein.

An electronic device according to various embodiments of the present invention may be a device that includes an image processing function. For example, the electronic device may include, but is not limited to, at least one of a smart phone, a tablet personal computer (PC), a mobile phone, a video phone, an e-book reader, a desktop PC, a laptop PC, a net book computer, a personal digital assistant (PDA), a portable multimedia player (PMP), an MP3 player, a mobile medical device, a camera, and a wearable device (e.g., a head-mounted-device (HMD) such as electronic glasses, electronic clothing, an electronic bracelet, an electronic necklace, an electronic appcessory, an electronic tattoo, or a smart watch).

According to some embodiments, the electronic device may be a smart home appliance having an image processing function. The smart home appliance or the electronic device may include at least one of a TV, a digital video disk (DVD) player, an audio set, a refrigerator, an air conditioner, a cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic frame.

According to some embodiments, the electronic device may include at least one of various medical devices (e.g., a magnetic resonance angiography (MRA) device, a magnetic resonance imaging (MRI) device, a computed tomography (CT) device, an image capturing device, and an ultrasonicator), a navigation device, a global positioning system (GPS) receiver, an event data recorder (EDR), a flight data recorder (FDR), a car infotainment device, electronic equipment for a ship (e.g., a navigation device for a ship or a gyro compass), avionics, a security device, a head unit for a vehicle, an industrial or home robot, an automated teller machine (ATM) for a financial institution, and a point of sales system for a store.

According to some embodiments, the electronic device may include at least one of a portion of a building/structure or furniture including a communication function, an electronic board, an electronic signature receiving device, a projector, and various measurement devices (e.g., a water, electricity, gas or electric wave measurement device). The electronic device according to various embodiments of the present invention may be one of the above-described various devices or two or more combinations thereof. Moreover, the electronic device according to various embodiments of the present invention may be a flexible device. Moreover, the electronic device according to various embodiments of the present invention is not limited to the above-described devices.

Electronic devices according to various embodiments are described below with reference to the accompanying drawings. The term ‘user’ used in various embodiments may indicate a person who uses an electronic device, or a device (e.g., an artificial-intelligence electronic device) that uses the electronic device.

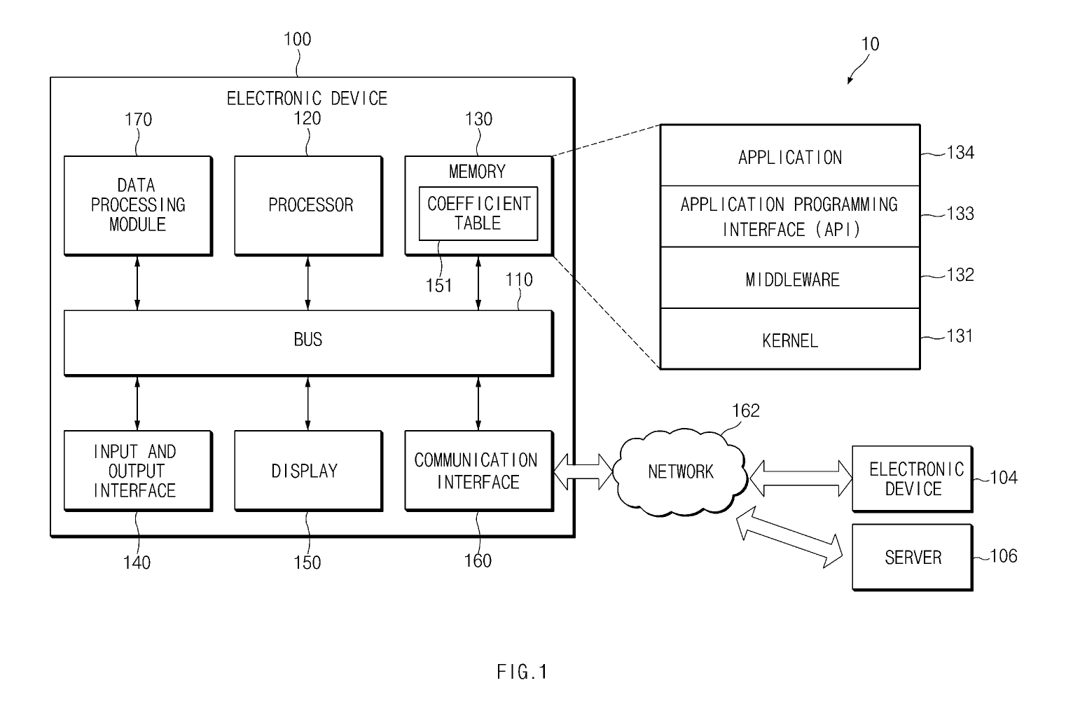

FIG. 1 shows a device operating system whereto various embodiments are applicable.

Referring to FIG. 1, an electronic device 100 according to an embodiment may include a device operating system 10, and have access to at least one external electronic device 104, and a network 162. The electronic device 100 and the electronic device 104 may form a communication channel through the network 162. For example, the electronic device 100 may form a communication channel with the electronic device 104 through a mobile communication network or an internet network. The electronic device 100 and the electronic device 104 may form a communication channel by using direct communication. For example, the electronic device 100 may form a direct communication channel with the electronic device 104 by using Bluetooth. For example, the electronic device 100 may form a direct communication channel with the electronic device 104 by using Wi-Fi direct communication module. Alternatively, the electronic device 100 may form a wired communication channel with the electronic device 104 by using a cable. The device operating system 10, may cause the electronic device 100 to use coefficient information substantially simultaneously to perform image data conversion and scaling together to perform image processing (e.g., image reduction according to a certain scale ratio) and transmit image processed data to the electronic device 104. In this operation, the electronic device 100 performs the image data conversion and the scaling together on an original image. Accordingly, it is possible to reduce the computational burden. Since it is possible to perform parallel processing in the image processing operation, it is possible to improve the image processing operational speed. Since the electronic device 100 may improve an image processing speed accordingly in the operation of transmitting data to the electronic device 104, it is also possible to support stable image transmission (to enable seamless image display by image processing).

The electronic device 104 may form a direct communication channel with a communication interface 160 of the electronic device 100 and receive image data from the electronic device 100. In this operation, the electronic device 104 may receive and output image processed data based on coefficient information that is applied to image data conversion and/or scaling.

According to various embodiments, the electronic device 104 may transmit specific image data to the electronic device 100. Image data transmitted by the electronic device 104 to the electronic device 100 may be image processed based on the coefficient information that is applied to the image data conversion and/or scaling.

According to various embodiments, the electronic device 104 may form a communication channel with the electronic device 100 through the network 162. For example, the electronic device 104 may include a cellular communication module and form a mobile communication channel with the electronic device 100. Alternatively, the electronic device 104 may include a WiFi communication module and form a mobile communication channel with the electronic device 100. The electronic device 104 may receive, from the electronic device 100, the image processed data based on the coefficient information that is applied to the image data conversion and/or scaling. Also, the electronic device 104 may store received the image processed data. According to various embodiments, the electronic device 104 may transmit specific image data to the electronic device 100. For example, the electronic device 104 may form a video call channel with the electronic device 100 and transmit an image collected by a camera to the electronic device 100. In this operation, the electronic device 104 may perform processing on the collected image based on the coefficient information applied to the image data conversion and/or scaling as described above, generate the image processed data and transmit the image processed data to the electronic device 100. The electronic device 104 may receive the image processed data by using the coefficient information as image data for a video call channel from the electronic device 100 and also output received data.

The network 162 may form a communication channel between the electronic device 100 and the electronic device 104. The network 162 may include network device components related to forming a mobile communication channel, for example. Alternatively, the network 162 may include network device components related to forming an internet communication channel. The network 162 may transmit image data from the electronic device 100 to the electronic device 104. Also, the network 162 may transmit image data from the electronic device 104 to the electronic device 100. To transmit image data from the electronic device 104 to the electronic device 100, the network 162 may form a video call channel.

Referring to FIG. 1, the electronic device 100 may include a bus 110, a processor 120, a memory 130, an input and output interface 140, a display 150, a communication interface 160, and a data processing module 170. Also, the electronic device 100 may further include at least one camera module. The camera module may operate to support various functions such as image-capturing related image collection and video-call related image collection functions. The electronic device 100 may perform image processing on stored image data, image data collected by a camera, and image data received from other electronic devices (e.g., electronic device 104). The electronic device 100 may store image processed data in the memory 130, transmit the data to other electronic devices or display the data on the display 150.

The bus 110 may be a circuit that connects the above-described components mutually and transfers communication (e.g., a control message) between the above-described components. For example, the bus 110 may transfer an input signal input through the input and output interface 140 to the processor 120. The bus 110 may transfer at least one of an original image received through the communication interface 160 and image processed data to at least one of the memory 130, the display 150, and the processor 120. The bus 110 may transfer the original image stored in the memory 130 to the processor 120 to enable image processed data having a certain scale ratio to be generated. The bus 110 may transfer at least one of the image processed data generated from the original image, the image processed data stored in the memory 130, or the image processed data received from other electronic devices to the display 150.

The processor 120 may receive a command from the above-described components (e.g., the memory 130, the input and output interface 140, the display 150, the communication interface 160, or the data processing module 170) through, for example, the bus 110. The processor 120 may decrypt a received command and perform operation or data processing according to the decrypted command.

The memory 130 may store a command or data received from the processor 120 or other components (e.g., the input and output interface 140, the display 150, the communication interface 160, or the data processing module 170) or generated by the processor 120 or other components. The memory 130 may include programming modules such as a kernel 131, middleware 132, an application programming interface (API) 133 or an application 134. Each of the above-described programming modules may be configured in software, firmware, hardware or a combination of two or more thereof.

The kernel 131 may control or manage system resources (e.g., the bus 110, the processor 120 or the memory 130) used for performing an operation or function implemented in other remaining programming modules such as middleware 132, an API 133, or an application 134. Also, the kernel 131 may provide an interface that enables the middleware 132, the API 133 or the application 134 to access and control or manage individual components of the electronic device 100.

The middleware 132 may function as an intermediary that enables the API 133 or the application 134 to communicate with the kernel 131 and thus transmit and receive data. Also, in order to process work requests received from applications 134, the middleware 132 may use a method of providing, for example, at least one of the applications 134 with a priority that may use the system resources (e.g., the bus 110, the processor 120 or the memory 130) of the electronic device 100 to perform control (such as, scheduling or load balancing) on the work requests.

The API 133 is an interface for allowing the application 134 to control a function provided from the kernel 131 or the middleware 132 and may include at least one interface or function (e.g., a command) for a file control, a window control, image processing or a text control, for example.

According to various embodiments, the application 134 may include, but is not limited to, an SMS/MMS application, an E-mail application, a calendar application, an alarm application, a health care application (e.g., an application measuring an exercise amount or blood sugar) or an environment information application (e.g., an application providing atmosphere, humidity, or temperature information). Additionally or alternatively, the application 134 may be an application related to an information exchange between the electronic device 100 and an external electronic device (e.g., the electronic device 104). The application related to the information exchange may include a notification relay application for relaying specific information to the external electronic device or a device management application for managing the external electronic device, for example.

For example, the notification relay application may include a function of relaying notification information generated from other applications (e.g., an SMS/MMS application, an E-mail application, a health care application and an environment information application) of the electronic device 100 to the external electronic device (e.g., the electronic device 104). Additionally or alternatively, the notification relay application may receive notification information from the external electronic device (e.g., the electronic device 104) and provide received information to a user. The device management application may manage (e.g., install or update) a function (e.g., the turn on/turn off operation of the external electronic device itself (or some parts thereof) or the brightness control of a display) of at least a portion of the external electronic device (e.g., the electronic device 104) communicating with the electronic device 100, an application operating on the external electronic device or a service (e.g., a call service or a message service) provided by the external electronic device.

According to various embodiments, the application 134 may include a designated application according to an attribute (e.g., type) of the external electronic device (e.g., the electronic device 104). For example, if the external electronic device is an MP3 player, the application 134 may include an application related to music playback. Similarly, if the external electronic device is a mobile medical device, the application 134 may include an application related to health care. According to an embodiment, the application 134 may include at least one of a designated application for the electronic device 100 and an application received from the external electronic device (e.g., the server device 106 or the electronic device 104).

According to various embodiments, the memory 130 may store at least one original image and at least a portion of the image processed data. According to an embodiment, the memory 130 may store an image scaling program. The image scaling program may be a program that generates image processed data obtained by scaling the original image at a certain scale ratio. The image scaling program may calculate coefficient information (e.g., matrix information) used in the process of incorporating the data conversion and scaling operation into one operation. When the coefficient information used in the operation of scaling an original image having a certain size at a designated image ratio is calculated, it may be stored in a coefficient table 151. The coefficient information stored in the coefficient table 151 may be equally used in the operation of scaling an original image having the same size at the designated image ratio. Thus, the image scaling program may include routine calculating coefficient information (at least one command set, or syntax related to a command set, function, template, class, etc.), an operation routine for data conversion and/or scaling of an original image by using calculated coefficient information, and a routine performing inversion on data obtained through the operation.

The coefficient table 151 may include coefficient information used for the operation of scaling an original image having a certain size according to a designated scale ratio. The coefficient table 151 may include at least a portion of the coefficient information calculated or collected (obtained from other electronic devices) according to a scale ratio to an original image. The coefficient information may vary depending on the size and scale ratio of an original image. For example, coefficient information used for the operation of changing a 100×100 original image to a 40×40 image may be different from coefficient information used for the operation of changing the 100×100 original information to a 48×48 image.

The input and output interface 140 may receive a command or data from a user through, for example, an input and output device (e.g., a sensor, a keyboard or a touch screen) and relay the command or data to the processor 120, the memory 130, the communication interface 160, or the data processing module 170 through the bus 110. For example, the input and output interface 140 may provide the processor 120 with data on a user touch input through a touch screen. Also, the input and output interface 140 may output, through the input and output device (e.g., a speaker or display), the command or data received from the processor 120, the memory 130, the communication interface 160, or the data processing module 170 through, for example, the bus 110. For example, the input and output interface 140 may output voice data processed through the processor 120, to a user through the speaker.

According to various embodiments, the input and output interface 140 may include a hardware key button (e.g., home key, side key, or power key), joystick, or keypad. The input and output interface 140 may include a virtual keypad displayed on the display 150 as an input device. The input and output interface 140 may generate an input signal related to the generation of image processed data according to user control. For example, the input and output interface 140 may generate an input signal designating a scale ratio of an original image (e.g., image collected by a camera, image stored in the memory 130 or image received externally). Also, the input and output interface 140 may generate an input signal that requests at least one of the operations of storing image processed data scaled at a designated or selected scale ratio in the memory 130, transmitting the image processed data to other electronic devices, and displaying the image processed data on the display 150. In this example, at least one of the storing, transmission and display of the image processed data may also be automatically performed irrespective of the generation of a separate input signal.

According to various embodiments, the input and output interface 140 may perform an audio processing related function. To perform an audio processing related function, the input and output interface 140 may include at least one of the speaker and microphone. When image data transmitted to and received from the electronic device 104 includes audio data, the input and output interface 140 may output corresponding audio data. When the electronic device 100 forms a communication channel including voice with another electronic device (e.g., electronic device 104), the input and output interface 140 may collect audio data by using the microphone and transfer collected data to the processor 120.

According to various embodiments, the input and output interface 140 may provide audio directions guiding a scale ratio or sound effect in the operation of image-processing an original image. The input and output interface 140 may output audio directions or sound effect related to performing at least one of the storing, transmission and display of the image processed data. Also, the input and output interface 140 may output audio directions or sound effects related to the deletion or movement of the image processed data. The output of the audio directions or sound effects may or may not be provided according to a user setting or depending on whether the electronic device 100 supports it.

The display 150 may show various information (e.g., multimedia data, text data, etc.) to a user. For example, the display 150 may display a locked screen or standby screen. The display 150 may display a screen performing a specific function, e.g., a music play app executing screen, a video play app executing screen, a broadcasting receiving screen, etc. depending on which function is performed. According to an embodiment, the display 150 may provide at least one of various screens related to image processing. For example, the display 150 may display an original image according to a resolution of the display 150. The display 150 may display image processed data obtained by scaling an original image at a certain image ratio. The display 150 may display a screen related to an image processing operation, a screen related to the storing of image processed data, a screen related to the transmission to another electronic device, or a screen related to image processed data received from the other electronic device. The display 150 may display at least a list of original images stored in the memory 130 and at least a list of image processed data. The display 150 may display the coefficient table 151 related to an image scale ratio stored in the memory 130.

According to an embodiment, the display 150 may display a screen related to obtaining an original image. For example, the display 150 may display a screen related to activating a camera, a screen related to obtaining a subject related image (original image, still image or video), or a screen related to storing an original image obtained by the camera, a screen related to calculating image processed data corresponding to the original image obtained by the camera. The display 150 may display a screen related to forming a communication channel with another electronic device (e.g., electronic device 104), a screen related to receiving an original image from the other electronic device, and a screen generating image processed data scaled at a designated or selected scale ratio based on a received original image.

The communication interface 160 may form a communication link between the electronic device 100 and an external device (e.g., the electronic device 104 or the server device 106). For example, the communication interface 160 may connect to the network 162 through wireless or wired communication to communicate with the external device. The wireless communication may include at least one of a wireless fidelity (WiFi), Bluetooth (BT), near field communication (NFC), Global Positioning System (GPS) and cellular communication (e.g., LTE, LTE-A, CDMA, WCDMA, UMTS, WiBro or GSM) scheme. The wired communication may include at least one of a universal serial bus (USB), high definition multimedia interface (HDMI), recommended standard 232 (RS-232) and plain old telephone service (POTS) scheme.

According to an embodiment, the network 162 may be a telecommunication network. The telecommunication network may include, but is not limited to, at least one of a computer network, internet, IOT (internet of things) and a telephone network. According to an embodiment, a protocol (e.g., a transport layer protocol, a data link layer protocol or a physical layer protocol) for communication between the electronic device 100 and the external device may be supported by at least one of the application 134, the application program interface 133, the middleware 132, the kernel 131 and the communication interface 160.

The communication interface 160 may include a plurality of communication modules when the electronic device 100 supports a plurality of communication schemes. For example, the electronic device 100 may include a communication module, such as a short range communication module or direct communication module, capable of forming a direct communication channel with the electronic device 104. The short range communication module or direct communication module may include at least one selected from various communications including, but not limited to, a WiFi direct communication module, Bluetooth communication module, and Zigbee communication module. Also, the direct communication module may include a wired communication module such as a cable.

According to an embodiment, the communication interface 160 may receive image data from at least one of the electronic device 104 and the server device 106. The communication interface 160 may transfer received image data to the data processing module 170. According to an embodiment, the communication interface 160 may transmit image processed data to at least one of the electronic device 104 and the server device 106 according to the control of the data processing module 170. The image processed data may be data processed by using the coefficient information obtained by data conversion and/or scaling.

The data processing module 170 may process at least some of information obtained from other components (e.g., the processor 120, the memory 130, the input and output interface 140 or the communication interface 160) and provide a user with processed information by using various methods. For example, the data processing module 170 may generate image processed data having a certain scale ratio based on an original image. The data processing module 170 may store generated image processed data in the memory 130, transmit the image processed data to other electronic devices or display the image processed data on the display 150. The above-described data processing module 170 may provide an image scaling method that may change a size and decrease distortion based on the hardware resources of the electronic device 100. A user may enjoy a scaled image and video having good quality by using a portable terminal employing a corresponding method and multimedia devices having various sizes.

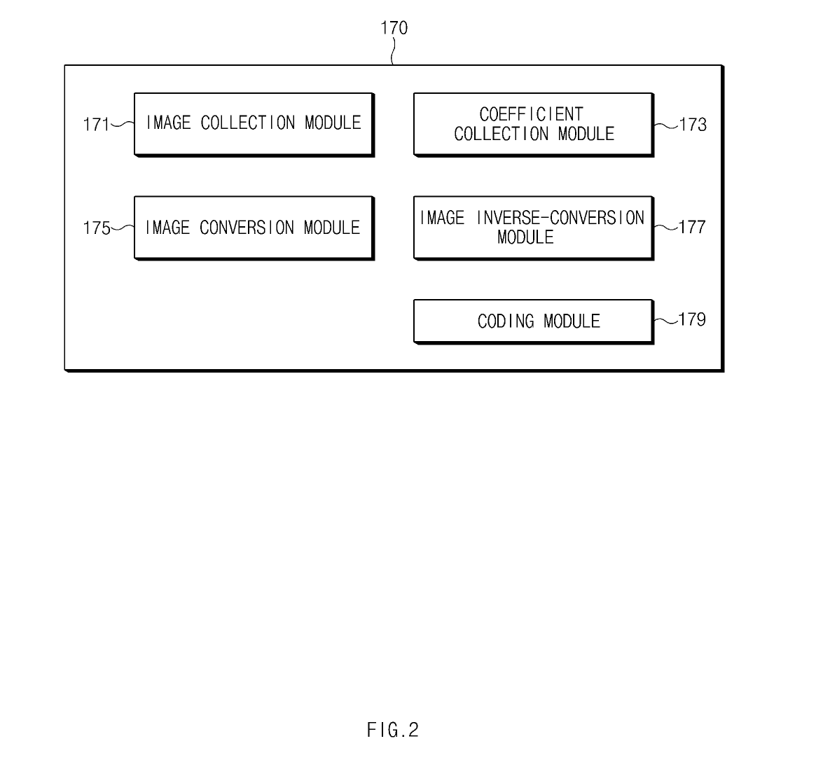

FIG. 2 is a block diagram of a data processing module of an electronic device according to various embodiments.

Referring to FIG. 2, the data processing module 170 may include an image collection module 171, a coefficient collection module 173, an image conversion module 175, an image inversion module 177, and a coding module 179.

The image collection module 171 may enable an original image to be collected. According to an embodiment, the image collection module 171 may activate a camera according to a user control or set schedule information and use an activated camera to collect an original image. The original image may have a particular resolution depending on the characteristics of the camera. According to an embodiment, the image collection module 171 may receive an original image from another electronic device (e.g., electronic device 104 or server device 106). To receive an original image from another electronic device, the image collection module 171 may establish a communication channel for transmitting or receiving the original image. Also, the image collection module 171 may receive and display a server page capable of selecting at least one original image of a number of original images and enable the original image corresponding to user selection to be received. According to an embodiment, the image collection module 171 may select at least one original image of a number of original images stored in the memory 130. To select at least one of a number of original images in the memory 130, the image collection module 171 may display a list of the original images stored in the memory 130 to be displayed, and select an original image corresponding to a user selection. The image collection module 171 may transfer a collected original image to the coefficient collection module 173 and the image conversion module 175.

The coefficient collection module 173 may check the size of the original image and a scale ratio for the image processed data to be scaled. To check the size of the original image, the coefficient collection module 173 may check information on the size of the original image from the header image of the original image. The coefficient collection module 173 may collect the scale ratio according to set information or a user input signal. To collect the scale ratio, the coefficient collection module 173 may support menu selection that enables a type of a scale ratio of a specific original image to be selected. For example, the coefficient collection module 173 may display a screen including types of scale ratios and obtain scale ratio information for the image processed data to be converted according to a selected type.

According to an embodiment, the coefficient collection module 173 may collect coefficient information according to the size of the original image and the scale ratio of image processed data to be converted. For example, the coefficient collection module 173 may check the coefficient table 151 to check whether there is the coefficient information according to the size of the original image and the scale ratio of image processed data to be converted. When there is corresponding coefficient information, the coefficient collection module 173 may provide the image conversion module 175 with the coefficient information. When there is no corresponding coefficient information, the coefficient collection module 173 may request the image conversion module 175 to calculate the coefficient information. In this operation, the coefficient collection module 173 may provide the image conversion module 175 with the size of the original image and the scale ratio information to convert the image processed data.

The image conversion module 175 may receive coefficient information from the coefficient collection module 173 and perform data conversion and scaling on the original image based on received coefficient information. The image conversion module 175 may transfer converted and scaled data to the image inversion module 177. The coefficient information may be an L×L matrix (e.g., 4×4 matrix, 8×8 matrix, or 16×16 matrix) having a fixed value according to the size and reduction ratio of an input and output image (original image and image processed data).

According to an embodiment, the image conversion module 175 may perform a zero-padding operation and data conversion, such as discrete cosine transform (DCT) to calculate coefficient information, when the size of the original image and the scale ratio information on the image processed data are received without receiving the coefficient information from the coefficient collection module 173. In this operation, the image conversion module 175 may perform the operation of calculating the coefficient information on an entire image scaling operation only once at an early stage. According to various embodiments, the image conversion module 175 may apply another conversion method, such as Fast Fourier Transform (FFT) or in addition to the DCT or another method, such as the wavelet transform and the DCT, to calculate the coefficient information.

According to an embodiment, the image conversion module 175 may calculate reduction ratios R_{X}, and R_{Y} and matrix transfer coefficients M and N by using Equation 1, where the width W₀ and height H₀ of the original image and the width W₁ and height H₁ of the image processed data are provided. In the notation <X>, <X> is the smallest integer that is not less than X.

M=<R_{X}>=<W₀/W₁>,N=<R_{Y}>=<H₀/H₁>. (Equation 1)

The image conversion module 175 may calculate augmented coefficients p and q determining the size of the zero-padding region in the X-axis direction and in the Y-axis direction by using Equation 2.

p=4×M−<4×R_{X}>,q=4×N−<4×R_{Y}> (Equation 2)

According to various embodiments, when a 1920×1080 image is reduced to a 512×240 image, the image conversion module 175 may calculate that the reduction ratio R_{Y} is 1080/240=4.5, the reduction ratio R_{X}=1920/512=3.75, the matrix transformation coefficient N is <4.5>=5, the matrix transformation coefficient M is <3.75>=4, the augmented coefficient p is 4×5−<4×4.5>=2, and the augmented coefficient q is 4×4−<4×3.75>=1. Thus, the image conversion module 175 may perform zero-padding by 2 on the Y-axis and 1 on the X-axis on a 18×15 partial image to reconfigure a 20×16 partial image. A 18×15 partial image is one unit block among whole image (e.g., (1920×1080)/(18×15)=7680 image). These unit blocks may be scaled into 4×4 blocks. Therefore, these unit blocks may resize into at least one of 512×240 image.

Regarding a zero-padded image, the image conversion module 175 may include a first type of identity matrix related to a region on which a portion of the original image data is disposed, a second type of identity matrix related to a region on which some original image data is disposed and a zero-padded region, a third type of identity matrix and a fourth type of identity matrix. The second type of identity matrix may be an identity matrix corresponding to a zero-padded region augmented in parallel to the Y-axis of the original image when zero padding is performed by a certain coefficient in the X-axis direction and Y-axis direction of the original image, for example. The third type of identity matrix may be an identity matrix corresponding to a zero-padded region augmented in parallel to the X-axis of the original image, for example. The fourth type of identity matrix may be an identity matrix corresponding to a zero-padded region augmented to a region on which the X-axis crosses the Y-axis. The original image data may be disposed from an upper left corner (e.g., (0, 0) on 2-axis coordinates) in the zero-padded image. Thus, the zero-padded region may be disposed on the right side or lower side of the original image.

The image conversion module 175 may perform data conversion on the zero-padded original image divided by using each type of identity matrix and select a low-frequency region from the image. For example, the image conversion module 175 may perform DCT on a region on which the original image data of the zero-padded images is disposed and select data disposed on a partial region (low-frequency region) of the upper left corner from a result obtained through the DCT to process image reduction. Similarly, the image conversion module 175 may perform the DCT on a region on which the original image data and zero-padded data of zero-padded images are disposed together and select data disposed on a partial region (low-frequency region) of the upper left corner from a result obtained through the DCT to process image reduction on each region. When image reduction on each region is completed, the image conversion module 175 may provide the image inversion module 177 with corresponding data.

The image inversion module 177 may perform inversion (e.g., inverse DCT) on data obtained by the DCT and reduction processing provided by the image conversion module 175. The image inversion module 177 may output image processed data that is obtained by converting frequency-domain image data into pixel-domain data through the inversion. The image inversion module 177 may enable the image processed data to be displayed on the display 150.

The coding module 179 may include an encoding module and a decoding module. The coding module 179 may receive image processed data provided by the image inversion module 177 and encode the image processed data. For example, the coding module 179 may enable encoded image processed data to be stored in the memory 130. The coding module 179 may enable the encoded image processed data to be transferred to another electronic device (e.g., electronic device 104 or server device 106). According to various embodiments, the coding module 179 may perform decoding on stored video. The coding module 179 may provide the image collection module 171 with a decoded image frame. The image collection module 171 may provide the image conversion module 175 with the decoded image frame provided by the coding module 179 to perform image processing.

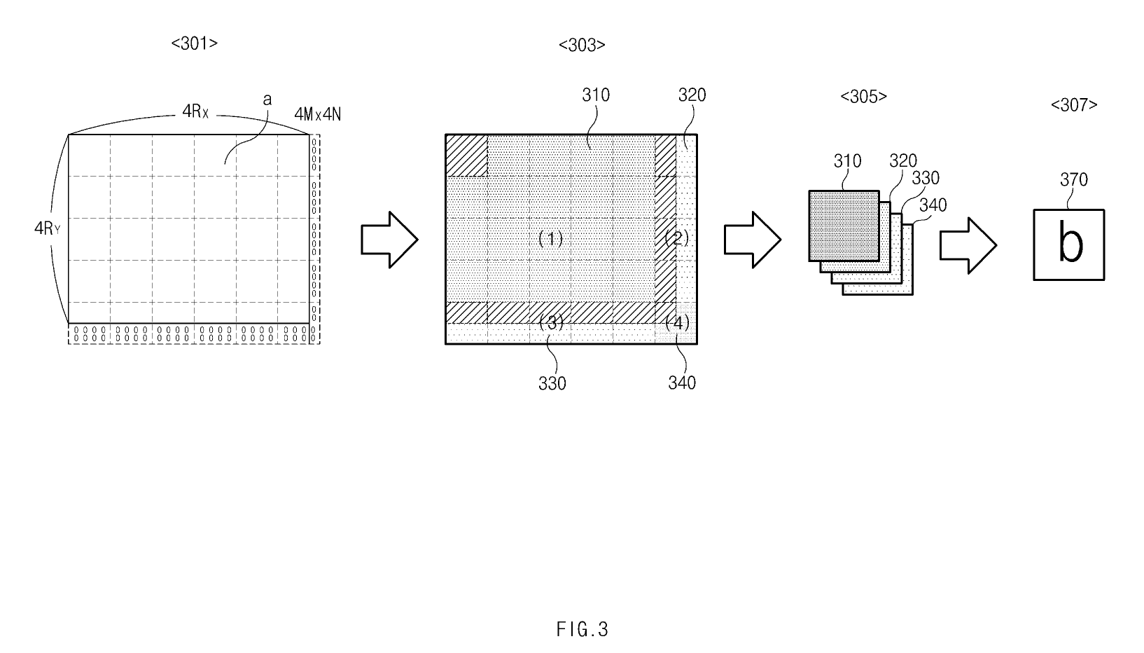

FIG. 3 shows image data conversion and scaling according to various embodiments.

Referring to FIG. 3, the data processing module 170 may perform a zero padding operation on an original image “a” as shown in section <301> to obtain a 4M×4N zero-padded image. According to an embodiment, the data processing module 170 may obtain the 4M×4N zero-padded image by augmenting coefficients p and q with respect to a 4R_{X}×4R_{Y} original image “a”. The relationship between the original image “a” and the 4M×4N zero-padded image may be expressed by Equation 3.

$${a}^{15 \times 18} = \vert \begin{matrix}{a}_{11} & 0 & 0 & 0 \\ 0 & 0 & 0 & 0 \\ 0 & 0 & 0 & 0 \\ 0 & 0 & 0 & 0\end{matrix} \vert + … + \vert \begin{matrix}0 & 0 & 0 & 0 \\ 0 & 0 & 0 & 0 \\ 0 & 0 & 0 & 0 \\ 0 & 0 & 0 & {a}_{NM}\end{matrix} \vert = {\sum }_{i = 1}^{N} {\sum }_{j = 1}^{M} {\overline{a}}_{ij}^{15 \times 18} = {\sum }_{i = 1}^{N} {\sum }_{j = 1}^{M} {s}_{ij}^{15 \times 16} \cdot {\hat{a}}_{ij}^{16 \times 20} \cdot {u}_{ij}^{20 \times 18} \qquad ( Equation 3 )$$

The original image “a” may be divided into M×N partial images aᵢⱼ and expressed by sum of 4R_{Y}×4R_{X} matrix āᵢⱼ, āᵢⱼ may be re-expressed by the product of identity matrices sᵢⱼ and uᵢⱼ considering augmented coefficients p and q and the zero-padded partial image âᵢⱼ.

The data processing module 170 may generate the 4M×4N zero-padded image with blocks having the same characteristic as shown in section [303]. For example, the data processing module 170 may divide the zero-padded image into a first region 310 on which there is only original image data, a second region 320 on which original image “a” data is on the left side of a block and zero-padded data is on the right side, a third region 330 on which original image “a” data is on the upper portion of a block and the zero-padded data is on the lower end, and a fourth region 340 on which the original image “a” data is on the upper left corner of the block and zero-mapped data is on remaining regions.

The first region 310 may have L×L blocks (e.g., 4×4 blocks) on which image data exists. The second region 320 may have blocks on which image data exists in a vertical direction and zero-padded data is disposed on remaining regions. The third region 330 may have blocks on which image data exists in a horizontal direction and zero-padded data is disposed on remaining regions. The fourth region 340 may have a block on which image data exists on the upper left corner and zero-padded data exists on remaining regions.

The data processing module 170 may perform the DCT (e.g., transformation to a frequency domain) on each region (e.g., first region 310, second region 320, third region 330 and fourth region 340) in section <305>. Identity matrix sᵢⱼ, uᵢⱼ may have four different matrices depending on four zero-padding cases. For example, sᵢⱼ, uᵢⱼ may be divided into (0, 0), (4-p, 0), (0, 4-q), and (4-p, 4-q) zero padding cases in a 4×4 identity matrix.

According to an embodiment, coefficient information sᵢⱼ, uᵢⱼ corresponding to the zero-padded first region 310 may be a 4×4 identity matrix. According to an embodiment, coefficient information corresponding to the zero-padded second region 320 may include a matrix sᵢⱼ [1,0,0,0;0,1,0,0;0,0,1,0;0,0,0,1] where q=0 and a matrix uᵢⱼ [1,0,0;0,1,0;0,0,1;0,0,0] where p=1, with respect to original image values, for example, [85, 88, 82; 83, 86, 84; 90, 96, 99; 91, 92, 98]. The data processing module 170 may multiply the left and right of the original image “a” by the identity matrices sᵢⱼ, uᵢⱼ so that the original image has the same value as the zero-padded image.

According to an embodiment, coefficient information corresponding to the zero-padded third region 330 may include a matrix sᵢⱼ [1,0,0,0;0,1,0,0] where q=2 and a matrix uᵢⱼ [1,0,0,0;0,1,0,0;0,0,1,0;0,0,0,0] where p=0, with respect to original image values, e.g., [85, 88, 82, 84; 90, 96, 99, 98]. The data processing module 170 may multiply the left and right of the original image “a” by the identity matrices so that the original image has the same value as the zero-padded image.

According to an embodiment, coefficient information corresponding to the zero-padded fourth region 340 may include a matrix sᵢⱼ [1,0,0,0;0,1,0,0] where q=2 and a matrix uᵢⱼ [1,0,0;0,1,0;0,0,1;0,0,0] where p=1, with respect to original image values, e.g., [85, 88, 82; 90, 96, 99]. The data processing module 170 may multiply the left and right of the original image by the identity matrices so that the original image is the same as the zero-padded image.

The relationship between the original image and the zero-padded image is represented by Equation 4 below:

$$\vert \begin{matrix}0 & 0 & 0 & 0 & & 0 & 0 & 0 & - \\ 0 & 0 & 0 & 0 & & 0 & 0 & 0 & - \\ 0 & 0 & 0 & 0 & … & 0 & 0 & 0 & - \\ 0 & 0 & 0 & 0 & & 0 & 0 & 0 & - \\ & & ⋮ & & ⋱ & & ⋮ & & \\ 0 & 0 & 0 & 0 & & 85 & 88 & 82 & - \\ 0 & 0 & 0 & 0 & & 90 & 96 & 99 & - \\ - & - & - & - & … & - & - & - & - \\ - & - & - & - & & - & - & - & -\end{matrix} \vert = \vert \begin{matrix}0 & 0 & 0 & 0 & & 0 & 0 & 0 & 0 \\ 0 & 0 & 0 & 0 & & 0 & 0 & 0 & 0 \\ 0 & 0 & 0 & 0 & … & 0 & 0 & 0 & 0 \\ 0 & 0 & 0 & 0 & & 0 & 0 & 0 & 0 \\ & & ⋮ & & ⋱ & & ⋮ & & \\ 0 & 0 & 0 & 0 & & 1 & 0 & 0 & 0 \\ 0 & 0 & 0 & 0 & & 0 & 1 & 0 & 0 \\ - & - & - & - & … & - & - & - & - \\ - & - & - & - & & - & - & - & -\end{matrix} \vert \cdot \vert \begin{matrix}0 & 0 & 0 & 0 & & 0 & 0 & 0 & 0 \\ 0 & 0 & 0 & 0 & & 0 & 0 & 0 & 0 \\ 0 & 0 & 0 & 0 & … & 0 & 0 & 0 & 0 \\ 0 & 0 & 0 & 0 & & 0 & 0 & 0 & 0 \\ & & ⋮ & & ⋱ & & ⋮ & & \\ 0 & 0 & 0 & 0 & & 85 & 88 & 82 & 0 \\ 0 & 0 & 0 & 0 & & 90 & 96 & 99 & 0 \\ 0 & 0 & 0 & 0 & … & 0 & 0 & 0 & 0 \\ 0 & 0 & 0 & 0 & & 0 & 0 & 0 & 0\end{matrix} \vert \cdot \vert \begin{matrix}0 & 0 & 0 & 0 & & 0 & 0 & 0 & - \\ 0 & 0 & 0 & 0 & & 0 & 0 & 0 & - \\ 0 & 0 & 0 & 0 & … & 0 & 0 & 0 & - \\ 0 & 0 & 0 & 0 & & 0 & 0 & 0 & - \\ & & ⋮ & & ⋱ & & ⋮ & & \\ 0 & 0 & 0 & 0 & & 1 & 0 & 0 & - \\ 0 & 0 & 0 & 0 & & 0 & 1 & 0 & - \\ 0 & 0 & 0 & 0 & … & 0 & 0 & 1 & 0 \\ 0 & 0 & 0 & 0 & & 0 & 0 & 0 & 0\end{matrix} \vert \qquad ( Equation 4 )$$

When it is assumed that a result obtained by performing the DCT on the an input image “a” is denoted A, A is represented by the product of Âᵢⱼ, Sᵢⱼ and Uᵢⱼ obtained by performing the DCT on the matrices âᵢⱼ sᵢⱼ and uᵢⱼ in Equation 3, and may be Equation 5:

A^{15×18}=Σᵢ₌₁^{N}Σⱼ₌₁^{M}Sᵢⱼ^{15×16}·Âᵢⱼ^{16×20}·Uᵢⱼ^{20×18} (Equation 5)

A DCT coefficient matrix Y on an L×L pixel-region matrix X may be calculated by Equation 6 below:

$$Y = F \times {F}^{T} , {F}_{ij} = {C}_{i} cos \frac{( 2 j + 1 ) iπ}{2 L} \qquad ( Equation 6 )$$

In this case, Cᵢ is

$$\sqrt{\frac{2}{L}}$$

when i is not zero, and Cᵢ is

$$\sqrt{\frac{1}{L}}$$

when i is zero.

Thus, DCT matrices S, A and U of Equation 5 may be calculated by Equation 7 below:

A^{15×18}=Σᵢ₌₁^{N}Σⱼ₌₁^{M}Sᵢⱼ^{15×16}·Âᵢⱼ^{16×20}·Uᵢⱼ^{20×18}=Σᵢ₌₁^{N}Σⱼ₌₁^{M}(Tᵢⱼ^{15×15}·sᵢⱼ^{15×16}·Fᵢⱼ^{16×16})·(Tᵢⱼ^{16×16}·âᵢⱼ^{16×20}·Fᵢⱼ^{20×20})·(Tᵢⱼ^{20×20}·Uᵢⱼ^{20×18}·Fᵢⱼ^{18×18})=Σᵢ₌₁^{N}Σⱼ₌₁^{M}(Tᵢⱼ^{15×15}·sᵢⱼ^{15×16})·(âᵢⱼ^{16×20})·(Uᵢⱼ^{20×18}·Fᵢⱼ^{18×18})=Bᵢⱼ^{15×18} (Equation 7)

In this case, since DCT matrices T and F form a transpose relationship in which a row and a column are reversed and the product of two matrices forms an orthonormal relationship, the product of two matrices may become an identity matrix I. Thus, since F×T or T×F have the same size as an identity matrix, an operation may be omitted.

In the description above, the identity matrices sᵢⱼ and uᵢⱼ may vary depending on the size of a zero-padded region. For example, an original image may be divided into L×L blocks such as a 8×8 block or a 16×16 block in various embodiments, and in this case, a zero-padded region may vary depending on the original image and the size of data by image processing. For example, the data processing module 170 may obtain a 8M×8N or 16M×16N zero-padded image or by augmented coefficients p and q with respect to a 8R_{X}×8R_{Y} or 16R_{X}×16R_{Y} original image “a”. Thus, the data processing module 170 may obtain the identity matrices sᵢⱼ and uᵢⱼ according to the size of each block, a zero-padded region, the size and scale ratio for the original image.

According to various embodiments, when there is no zero-padded region, it is possible to omit or remove an identity matrix defining the zero-padded region or include only an identity matrix corresponding to the first case described above.

The data processing module 170 may select a low-frequency region among data obtained by the DCT in section <307> and exclude remaining regions to obtain a reduced target image 370. In this case, the data processing module 170 may perform inverse DCT on the image data to convert a frequency domain into a pixel domain. The DCT matrix A of the original image “a” may be represented by L×L (e.g., 4×4 or 8×8) coefficient block Bᵢⱼ that forms M×N blocks. The data processing module 170 may select and recover only B₁₁ corresponding to a low-frequency domain as represented by Equation 8, when the low-frequency domain is selected from a frequency domain to decrease distortion due to image reduction.

B₁₁^{4×4}=Σᵢ₌₁^{N}Σⱼ₌₁^{M}(Îᵢⱼ^{4×15}·Tᵢⱼ^{15×15}·sᵢⱼ^{15×16})·(âᵢⱼ^{16×20})·(uᵢⱼ^{20×18}·Fᵢⱼ^{18×18}·Īᵢⱼ^{18×4})=Σᵢ₌₁^{N}Σⱼ₌₁^{M}(H′ᵢⱼ^{4×16})·(âᵢⱼ^{16×20})·(Q′ᵢⱼ^{20×4})=Σᵢ₌₁^{N}Σⱼ₌₁^{M}(Hᵢⱼ^{4×4})·(âᵢⱼ^{4×4})·(Qᵢⱼ^{4×4}) (Equation 8)

The data processing module 170 may obtain a 4×4 DCT matrix B11 with respect to a 16×20 input partial image âᵢⱼ when multiplying the left and right of the equation calculated in Equation 7 by a matrix Î[1,0,0,0](horizontal matrix) and a matrix Î[1,0,0,0,0](vertical matrix) for extracting only the first 4×4 region.

In this case, matrices multiplied with the left and right of âᵢⱼ may be a 4×16 H′ᵢⱼ (e.g., Îᵢⱼ^{4×15}·Tᵢⱼ^{15×15}·sᵢⱼ^{15×16}) matrix, and a 20×4 Q′ᵢⱼ (e.g., Uᵢⱼ^{20×18}·Fᵢⱼ^{18×18}·Īᵢⱼ^{18×4}) matrix. Since the original image ahas zero values on other regions excluding an L×L (e.g., 4×4) region having a unit of N×M as in the embodiment described in Equation 4, all of matrices H′ᵢⱼ^{4×4}, âᵢⱼ and Q′ᵢⱼ^{4×4} may be calculated with respect to a specific L×L (e.g., 4×4 or 8×8) block.

Thus, L×L (e.g., 4×4) first transfer matrices Hᵢⱼ and Qᵢⱼ that may perform DCT and size reduction together may be calculated to be coefficient information fixed by the original image “a” and the size of data to be image processed, as described above. The coefficient information may be pre-calculated and stored in a tabular form. The image conversion module 175 may calculate coefficient information on an initial frame and then equally apply calculated coefficient information to other frames, without a need to calculate coefficient information for each frame with respect to specific video. Also, since the image conversion module 175 performs a standardized matrix operation of an L×L (e.g., 4×4) block on an independent partial image, it is possible to perform parallel operation applying the same coefficient information to each L×L bock. Also, when a zero-padded region is considered, the image conversion module 175 may perform data conversion and scaling through parallel operation on determined coefficient information in units of a zero-padded region to improve operation speed.

As described above, the electronic device 100 according to various embodiments may maintain the resolution of an image even after reducing an image and video to be used. Accordingly, the electronic device 100 may apply the above-described image processing to an e-Book, a gallery or a thumbnail image so that a reduced image is expressed more clearly than before. Also, the electronic device 100 may support a real number (or float) reduction ratio to output video having stable quality through links with multimedia devices having various sizes.

The data processing module 170 may apply the inverse DCT matrices T and F to B₁₁ obtained by first transformation as represented in Equation 9:

b₁₁^{4×4}=T^{4×4}·B₁₁^{4×4}·F^{4×4} (Equation 9)

As described above, the electronic device 100 according to an embodiment may use an L×L first transfer matrix (matrix associated with data conversion (DCT) and scaling (image reduction)) and a Lx L secondary transfer matrix (inverse transform (e.g., inverse DCT)) to reduce an image to decrease computational burden. Since all operations are performed by multiplication of L×L matrices, the electronic device 100 may improve a speed through parallel processing. Also, since the coefficient collection module 173 may be disposed independently from the image conversion module 175, the electronic device 100 may store coefficient information in the coefficient table 151 to obtain an operation gain. The electronic device 100 may decrease the number of zero padding cases for obtaining the first and secondary transfer matrices to four, thereby improving operation speed.

According to various embodiments, the electronic device according to an embodiment may include a data processing module that checks scale ratio information on an original image and applies, coefficient information to be applied to the data conversion and scaling of the original image based on the ratio information, to at least partial data of the original image to obtain image processed data corresponding to the scale ratio, and at least one of a storage module storing the original image, a camera collecting the original image, and a communication interface receiving the original image.

According to various embodiments, the storage module may store a coefficient table including coefficient information matching with size information and ratio information.

According to various embodiments, the control module may obtain a zero-padded partial image based on the size information and the scale ratio information on a specific frame of the original image, and obtain at least one identity matrix as the coefficient information according to the correspondence between the zero-padded partial image and the partial image of the original image.

According to various embodiments, the control module may apply the coefficient information to at least another piece of partial data of the original image.

According to various embodiments, the control module may store the coefficient information mapped to the size information and the scale ratio information on the original image in the storage module.

According to various embodiments, the control module may divide the original image into blocks having a certain determined size and determine the size of a region to be zero-padded based on the size of the block and the scale ratio information.

According to various embodiments, the control module may divide the original image into blocks having a certain determined size and apply the coefficient information to at least one of the blocks.

According to various embodiments, the size of the block may be any one of 4×4, 8×8, and 16×16, and the control module may perform parallel processing on the partial images of the original image in units of the size of the block.

According to various embodiments, the control module may obtain at least one of an identity matrix corresponding to a region on which there is only original image data from the zero-padded partial image and at least one identity matrix corresponding to a region on which there are the original image and the zero-padded data from the zero-padded partial image.

According to various embodiments, the control module may convert the original image data into a frequency domain and obtain coefficient information set to select a value disposed on a low-frequency domain from the frequency domain obtained through conversion.

According to various embodiments, the control module may inversely convert the frequency domain image processed data from the frequency domain into the pixel domain.

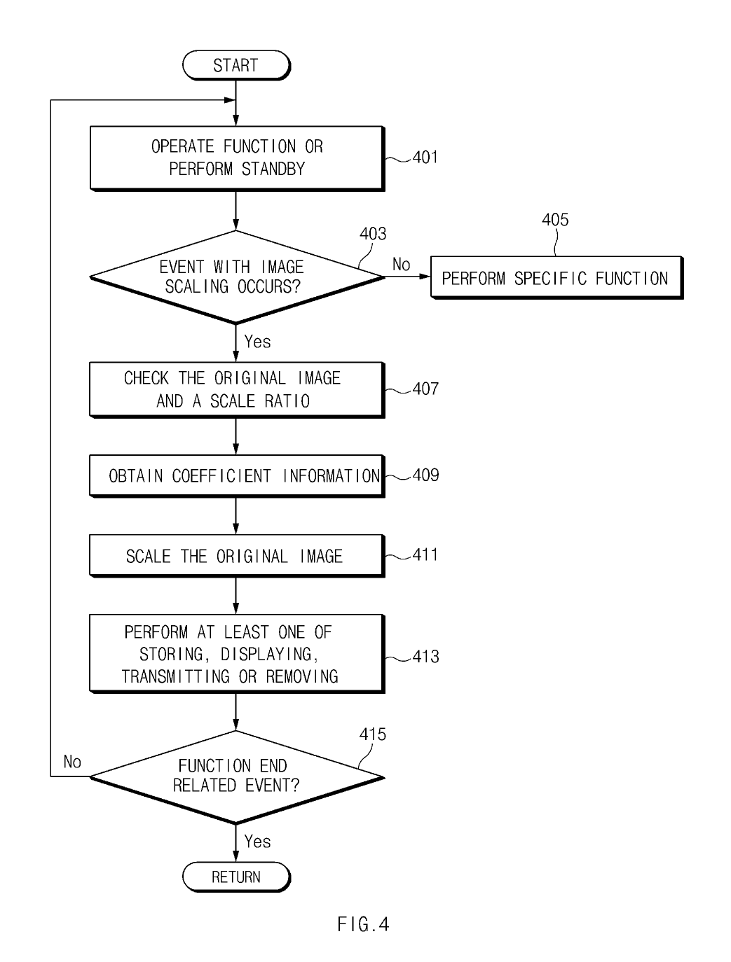

FIG. 4 represents an image processing method according to various embodiments.

Referring to FIG. 4, the image processing method according to an embodiment may enable the data processing module 170 to operate function or perform standby at block 401. In the operation, the data processing module 170 may form a communication channel with another electronic device (e.g., electronic device 104 or server device 106). The data processing module 170 may provide a screen to be capable of receiving a selection of at least one of a number of original images stored in the storage module 150. The data processing module 170 may activate a camera to capture an original image.

The data processing module 170 may check in block 403 whether there is an event associated with image scaling. The data processing module 170 may check whether there is an event associated with selecting a specific original image (e.g., event associated with selecting an original image and an image reduction ratio) on an image scaling related screen. Alternatively, the data processing module 170 may check whether an original image is collected from an activated camera. The data processing module 170 may check whether there is an event set to request the scaling of a collected original image to a specific value. The data processing module 170 may check whether there is an original image associated with a voice call or image data transmission and received from another electronic device, and check whether there is an event set to request the scaling of a received original image to a specific value.

When there is no image scaling related event, the data processing module 170 may allow a function corresponding to an event occurring (e.g., music playback function, broadcasting reception function, or web access function according to an event type) to be performed in block 405. Alternatively, when there is no event, the data processing module 170 may maintain a previously performed function or the previous state of the electronic device 100 (e.g., sleep mode state in which the display module 140 is turned off).

In block 403, if there is an image scaling related event, the data processing module 170 may check the original image and a scale ratio in block 407. For example, the data processing module 170 may use the original image and size information for the original image to check scale ratio information for the image processed data to be generated. The size of the original image may be obtained through header information. The scale ratio may be a designated value or determined by a user input.

The data processing module 170 may obtain coefficient information to be applied to image data conversion and scaling in block 409. For example, the data processing module 170 may instruct the data processing module 170 to obtain coefficient information. The data processing module 170 may check the coefficient table 151 stored in the storage module 150 to check whether there is coefficient information corresponding to the size and reduction ratio of the original image. When there is corresponding information in the storage module 150, it is possible to collect coefficient information (e.g., H′ᵢⱼ, Q′ᵢⱼ) from the coefficient table 151. When there is no corresponding information, the data processing module 170 may calculate coefficient information to be applied to data conversion and scaling together the image data conversion and scaling previously described in FIG. 3.

The data processing module 170 may scale the original image based on coefficient information in block 411. For example, the data processing module 170 may multiply the original image by coefficient information, and select low-frequency data of low-frequency domains from calculated information to perform image data conversion and scaling to generate image processed data.

The data processing module 170 may perform at least one of operations of storing, displaying, transmitting or removing image processed data in operation 413. For example, the data processing module 170 may allow the image processed data to be stored in the storage module 150 automatically or according to a user input. The data processing module 170 may automatically transmit the image processed data to another electronic device busy making a video call. The data processing module 170 may allow the image processed data to be displayed on the display module 140. According to various embodiments, the data processing module 170 may also remove the image processed data according to a user input.

The data processing module 170 may check in block 415 whether there is a function end related event. When there is no function end related event in block 415, the data processing module 170 may proceed to block 403 to re-perform the following operations. When there is the function end related event in block 415, the data processing module 170 may end an image reduction function, and proceed to block 401 or block 405 to perform a previously performed function or a specific function according to user control. Alternatively, the data processing module 170 may support a sleep mode state, a locked screen state, or a standby screen state.

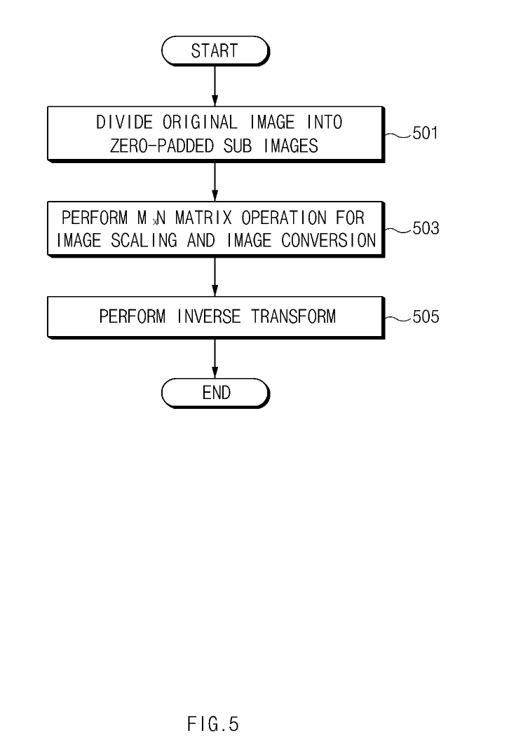

FIG. 5 represents an image scaling method according to various embodiments.

Referring to FIG. 5, the data processing module 170 may divide an original image into zero-padded sub images (e.g., N×N images including L×L blocks) in block 501. For example, the data processing module 170 may perform zero padding on the partial image calculated according to the size of the original image and the scale ratio of the image processed data to be generated. According to an embodiment, the data processing module 170 may perform three-line zero-padding on the x-axis and one-line zero-padding on the y-axis, on the 17×15 partial image calculated according to the size of the original image and the scale ratio of data to be image processed. The data processing module 170 may perform one-line zero-padding on the x-axis and no zero-padding on the y-axis, on the 19×16 partial image calculated according to the size of the original image and the scale ratio of data to be image processed.

The data processing module 170 may perform an M×N matrix operation for image scaling and image conversion in block 503. For example, the data processing module 170 may apply determined coefficient information provided for the DCT and scaling to the above-described partial images or calculate coefficient information based on the data scaling and conversion previously described in FIG. 3 to apply calculated information thereto. By applying the above-described coefficient information, the data processing module 170 may calculate data obtained by applying DCT and scaling to the partial images.

The data processing module 170 may perform inverse transform in order to convert the region (frequency domain) of data to which DCT and scaling have been applied, into a pixel region in operation 505. For example, the data processing module 170 may perform inverse DCT on a data value calculated in the frequency domain to convert a value obtained through conversion into a data value of the pixel region.

As described above, according to various embodiments, the image processing method according to an embodiment may include the operations of: obtaining scale ratio information on an original image, obtaining coefficient information to be applied to data conversion and scaling of the original image based on the ratio information, and applying the coefficient information to at least some data of the original image to obtain image processed data corresponding to the scale ratio.

According to various embodiments, the operation of obtaining the coefficient information may include the operation of detecting coefficient information matching with the size information and the ratio information in a coefficient table.

According to various embodiments, the operation of obtaining the coefficient information may include the operations of obtaining a zero-padded partial image based on the size information and the scale ratio information on a specific frame of the original image, obtaining at least one identity matrix as the coefficient information according to the correspondence between the zero-padded partial image and the partial image of the original image, and obtaining the identity matrix as the coefficient information.

According to various embodiments, the method may further include the operation of applying the coefficient information to at least some other data of the original image.

According to various embodiments, the method may further include the operation of storing the coefficient information mapped to the size information and the scale ratio information of the original image.

According to various embodiments, the operation of obtaining the zero-padded partial image may include the operations of dividing the original image into blocks having a certain determined size, and determining the size of a region to be zero-padded based on the size of the block and the scale ratio information.

According to various embodiments, the operation of obtaining the image processed data may include the operations of dividing the original image into blocks having a certain determined size, and applying the coefficient information to at least one of the blocks.

According to various embodiments, the size of the block may be any one of 4×4, 8×8, and 16×16, and the operation of obtaining the image processed data may include the operation of performing parallel processing on the partial images of the original image in units of the size of the block.

According to various embodiments, the operation of obtaining the identity matrix may include the operations of obtaining an identity matrix corresponding to a region on which there is only original image data from the zero-padded partial image, and obtaining at least one identity matrix corresponding to a region on which there are the original image and the zero-padded data from the zero-padded partial image.

According to various embodiments, the operation of obtaining the coefficient information may include the operations of converting the original image data into a frequency domain, and obtaining coefficient information set to select a value disposed on a low-frequency domain from the frequency domain obtained through conversion.

According to various embodiments, the method may further include the operation of inversely converting the image processed data from the frequency domain into a pixel region.

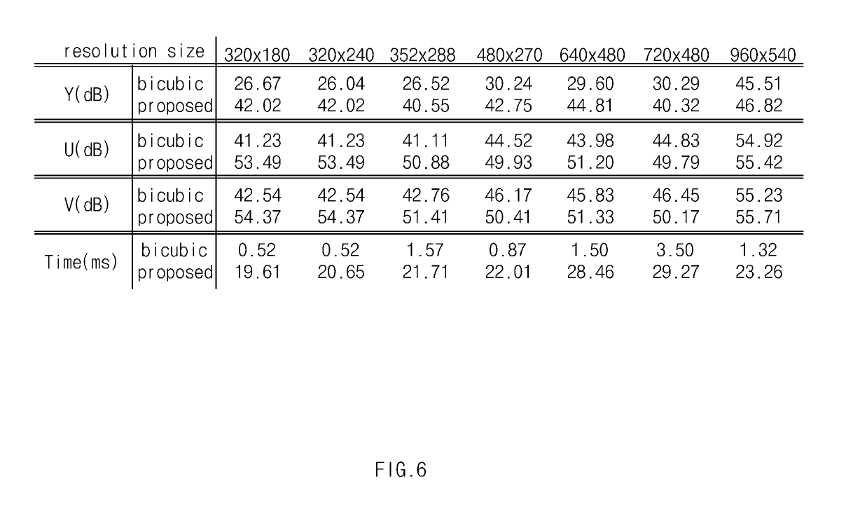

FIG. 6 shows a table of resolution and a speed results according to image scaling according to various embodiments.

Referring to FIG. 6, a table represents the resolution and processing speeds of an image in an embodiment that reduces a 1920×1080 image to have various sizes. The table may show the processing speeds and peak signal to noise ratio (PSNR) values of the proposed invention and bicubic reduction for each of channels Y, U and V of an image. In this case, the original image for reduction uses Lanczos reduction. Referring to the table, it may be seen that there are speed differences and resolution differences of about 1 dB to about 16 dB between the image processing methods described in various embodiments and another method according to the size of an image. Also, the image processing method described in various embodiments may provide a processing speed of about 33 ms at which it is possible to process 30 frames per second (fps) video in real time.

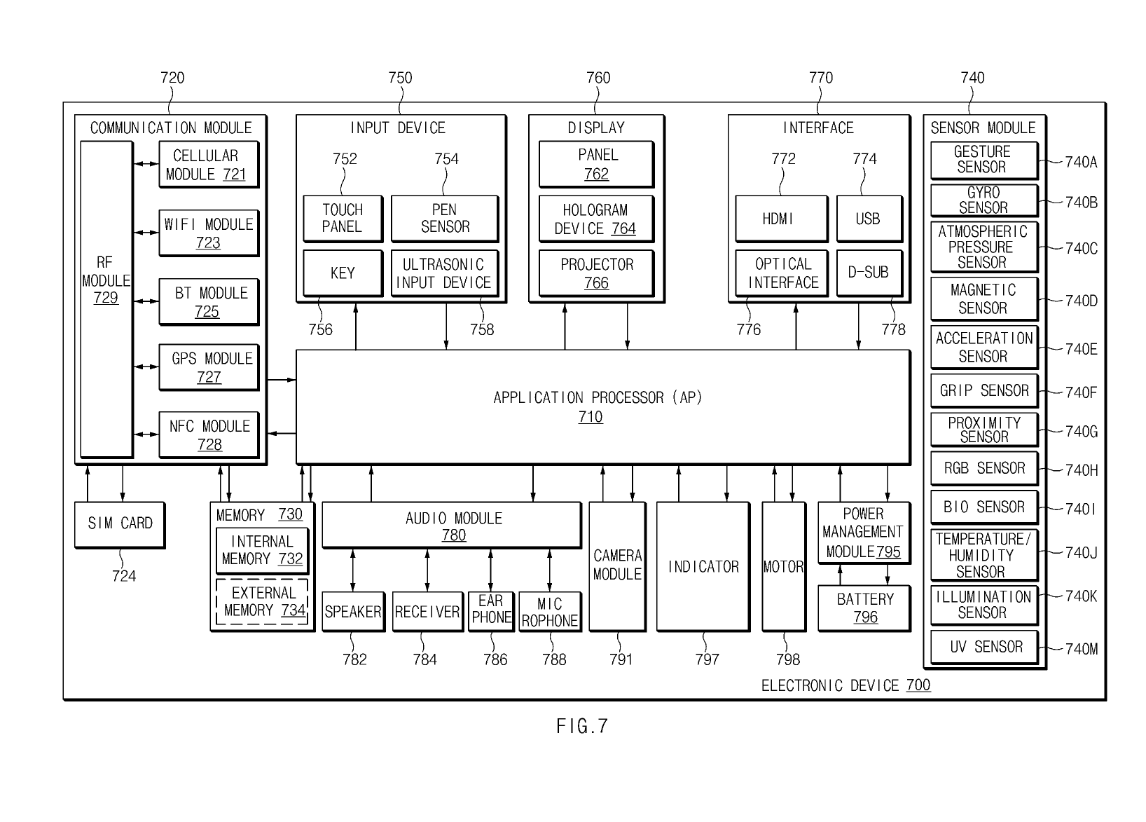

FIG. 7 shows a block diagram of an electronic device 700 according to various embodiments.

The electronic device 700 may include all or some of the electronic device 100 shown in FIG. 1, for example. Referring to FIG. 7, the electronic device 700 may include one or more applications (APs) 710, a communication module 720, a subscriber identification module (SIM) card 724, a memory 730, a sensor module 740, an input device 750, a display 760, an interface 770, an audio module 780, a camera module 791, a power management module 795, a battery 796, an indicator 797, and a motor 798.

The AP 710 may execute an operating system or application programs to control a plurality of hardware or software components connected to the AP 710 and may perform processing and operation on various pieces of data including multimedia data. The AP 710 may be implanted in a system on chip (SoC) for example. According to an embodiment, the AP 710 may further include a graphic processing unit (GPU) (not shown).

The communication module 720 (e.g., the communication module 160) may perform data transmission and reception when communication is made between the electronic device 700 (e.g., the electronic device 100) and other electronic devices (e.g., the electronic device 104 or the server device 106) connected through a network. The communication module 720 may receive image processed data from other electronic devices or transmit the image processed data to the other electronic devices. According to an embodiment, the communication module 720 may include a cellular module 721, a WiFi module 723, a BT module 725, a GPS module 727, an NFC module 728, and a radio frequency (RF) module 729.

The cellular module 721 may provide a voice call, a video call, a text message service, or an internet service through a communication network (such as an LTE, LTE-A, CDMA, WCDMA, UMTS, WiBro or GSM network). Also, the cellular module 721 may use, for example, a subscriber identity module (such as a SIM card 724) to perform the identification and authentication of an electronic device in a communication network. According to an embodiment, the cellular module 721 may perform at least some of functions that the AP 710 may provide. For example, the cellular module 721 may perform at least some of multimedia control functions.

According to an embodiment, the cellular module 721 may include a communication processor (CP). Also, the cellular module 721 may be implemented in a SoC, for example. FIG. 7 shows components such as a cellular module 721 (such as a communication processor), a memory 730 and a power management module 795 separately from the AP 710 but according to an embodiment, the AP 710 may be implemented to include at least some (such as a cellular module 721) of the above-described components.

According to an embodiment, the AP 710 or the cellular module 721 (such as a communication processor) may load, on volatile memories, commands or data received from at least one of a non-volatile memory connected to thereto or another component, and may process the commands or data. Also, the AP 710 or the cellular module 721 may store, on non-volatile memories, data received from at least one of other components or generated by at least one of other components.

Each of the WiFi module 723, the BT module 725, the GPS module 727 and the NFC module 728 may include a processor for processing data transmitted and received through a corresponding module, for example. FIG. 7 shows each of the cellular module 721, the WiFi module 723, the BT module 725, the GPS module 727, and the NFC module 728 as separate blocks, but according to an embodiment, at least some (e.g., two or more) of the cellular module 721, the WiFi module 723, the BT module 725, the GPS module 727, and the NFC module 728 may be included in one integrated chip (IC) or an IC package. For example, at least some (such as a communication processor corresponding to the cellular module 721 and a WiFi processor corresponding to the WiFi module 723) of processors corresponding to the cellular module 721, the WiFi module 723, the BT module 725, the GPS module 727, and the NFC module 728, respectively may be implemented in one SoC.

The RF module 729 may perform data transmission and reception, such as transmission and reception of an RF signal. The RF module 729 may include e.g., a transceiver, a power amp module (PAM), a frequency filter or a low noise amplifier (LNA) though not shown. Also, the RF module 729 may further include a part such as a conductor or wire for transmitting and receiving electromagnetic waves in a free space when performing wireless communication. Although FIG. 7 shows that the cellular module 721, the WiFi module 723, the BT module 725, the GPS module 727, and the NFC module 728 share one RF module 729, at least one of the cellular module 721, the WiFi module 723, the BT module 725, the GPS module 727, and the NFC module 728 may also transmit and receive an RF signal through a separate RF module according to an embodiment.

The SIM card 724 may be a card including a subscriber identity module and may be inserted into a slot that is formed on a specific location on an electronic device. The SIM card 724 may include unique identification information (such as an integrated circuit card identifier (ICCID)) or subscriber information (such as an international mobile subscriber identity (IMSI)).

The memory 730 (e.g., the memory 130) may include an internal memory 732 or an external memory 734. The internal memory 732 may include at least one of e.g., a volatile memory (such as a dynamic RAM (DRAM), a static RAM (SRAM), or a synchronous dynamic RAM (SDRAM)) and a non-volatile memory (such as an one time programmable ROM (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment, the internal memory 732 may be a solid state drive (SSD). The external memory 734 may further include a flash drive, such as a compact flash (CF) drive, a secure digital (SD) drive, a micro secure digital (micro-SD) drive, a mini secure digital (mini-SD) drive, or an extreme digital (xD) drive, or a memory stick. The external memory 734 may be functionally connected to the electronic device 700 through various interfaces. According to an embodiment, the electronic device 700 may further include a storage device (or storage medium) such as an HDD. According to an embodiment, the memory 730 may store a coefficient table. The coefficient table stored in the memory 730 may be transmitted to other electronic devices through the communication module 720. Alternatively, the coefficient tale may be received from other electronic devices through the communication module 720 and stored in the memory 730.

The sensor module 740 may measure a physical quantity or sense the operation state of the electronic device 700 to convert measured or sensed information into an electrical signal. The sensor module 740 may include at least one of a gesture sensor 740A, a gyro sensor 740B, an atmospheric pressure sensor 740C, a magnetic sensor 740D, an acceleration sensor 740E, a grip sensor 740F, a proximity sensor 740G, a color sensor 740H (such as a red, green, blue (RGB) sensor), a bio sensor 740I, a temperature/humidity sensor 7403, an illumination sensor 740K or a ultra violet (UV) sensor 740M, for example. Additionally or alternatively, the sensor module 740 may include, for example, an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown) or a fingerprint sensor (not shown). The sensor module 740 may further include a control circuit for controlling at least one sensor that is included in the sensor module 740.

The input device 750 may include a touch panel 752, a (digital) pen sensor 754, a key 756 or an ultrasonic input device 758. The touch panel 752 may recognize a touch input by using at least one of a capacitive, pressure-sensitive, infrared and ultrasonic techniques, for example. Also, the touch pane 752 may also further include a control circuit. In the case of the capacitive technique, a physical contact or proximity awareness is possible. The touch panel 752 may further include a tactile layer. In this case, the touch panel 752 may provide a user with a tactile response.

The (digital) pen sensor 754 may be implemented by using the same or similar method as that of obtaining a user's touch input or by using a separate sheet for recognition, for example. The key 756 may include, for example, a physical button, an optical key or a keypad. The ultrasonic input device 758 is a device that may sense a sound wave with a microphone (e.g., a microphone 788) from the electronic device 700 and check data, through an input tool generating an ultrasonic signal, and the ultrasonic input device 256 may thus perform wireless recognition. According to an embodiment, the electronic device 700 may also use the communication module 720 to receive a user input from an external device (such as a computer or server) connected thereto.

The display 760 (such as a display 150) may include a panel 762, a hologram device 764 or a projector 766. The panel 762 may be a liquid-crystal display (LCD) or an active-matrix organic light-emitting diode (AM-OLED), for example. The panel 762 may be implemented flexibly, transparently or wearably, for example. The panel 762 may also be integrated into the touch panel 752 so that they are implemented in one module. The hologram device 764 may use the interference of light to show a stereoscopic image in the air. The projector 766 may project light onto a screen to display an image. The screen may be located internal or external to the electronic device 700, for example. According to an embodiment, the display 760 may further include a control circuit for controlling the panel 762, the hologram device 764 or the projector 766. The above-described display 760 may display at least one of a stored original image and imaged-processed data. Alternatively, the display 760 may display at least one of an original image provided by other electronic devices or imaged-processed data.

The interface 770 may include, for example, a HDMI 772, a universal serial bus (USB) 774, an optical interface 776 or a D-subminiature 778. The interface 770 may be included in e.g., the communication interface 160 shown in FIG. 1. Additionally or alternatively, the interface 770 may include a mobile high-definition link (MHL) interface, an SD card/multi-media card (MMC) interface or an infrared data association (IrDA) interface, for example.

The audio module 780 may convert sound into an electrical signal or vice versa. At least some components of the audio module 780 may be included in e.g., the input and output interface 140 shown in FIG. 1. The audio module 780 may process sound information input or output through a speaker 782, a receiver 784, an earphone 786 or the microphone 788, for example.

The camera module 791 is a device that may capture still pictures and video, and according to an embodiment, it is possible to include one or more image sensors (such as a front sensor or rear sensor), lens (not shown), an image signal processor (ISP, not shown), or a flash (not shown) (e.g., an LED or a xenon lamp). The camera module 791 may capture an original image as mentioned above. The original image captured by the camera module 791 may be converted into image processed data having a certain scale ratio according set information. In this operation, since the coefficient information is applied, data conversion and scaling may be performed together. According to various embodiments, the original image (a plurality of videos or still images) captured by the camera module 791 may be converted into image processed data having a certain scale ratio designated by a user.

The power management module 795 may manage the power of the electronic device 700. Although not shown, the power management module 795 may include a power management integrated circuit (PMIC), a charger IC, or a battery or fuel gauge, for example.

The PMIC may be included in an IC or a SoC semiconductor, for example. Charging techniques may be classified into wired and wireless techniques. The charger IC may charge the battery and prevent overvoltage or overcurrent from a charger. According to an embodiment, the charger IC may include a charger IC for at least one of a wired charging technique and a wireless charging technique. The wireless charging technique includes, for example, a magnetic resonance type, a magnetic induction type, or an electromagnetic wave type, and an additional circuit for wireless charging may be added such as a coil loop, a resonance circuit, or a rectifier.

The battery gauge may measure the level, current or temperature of the battery 796, or the voltage of the battery 896 during charging, for example. The battery 796 may store or generate electricity and use stored or generated electricity to supply power to the electronic device 700. The battery 796 may include a rechargeable battery or a solar battery, for example.

The indicator 797 may show the specific states of the electronic device 700 or a portion (e.g., the AP 710) of the electronic device, such as a booting state, a message state and a charged state. The indicator 797 may indicate information on an image processing state (at least one of a state in which an original image is converted into image processed data having a certain scale ratio, certain scale ratio information and size information on displayed image processed data). The motor 798 may convert an electrical signal into mechanical vibration. Although not shown, the electronic device 700 may include a processing device (e.g., a GPU) for supporting a mobile TV. The processing device for supporting the mobile TV may process media data according to a standard such as digital multimedia broadcasting (DMB), digital video broadcasting (DVB) or media flow.

Each of the above-described elements of the electronic device according to various embodiments of the present invention may include one or more components and the names of corresponding elements may vary depending on the category of an electronic device. The electronic device according to various embodiments of the present invention may include at least one of the above-described elements and some elements may be left out or other elements may be further included. Also, some of the elements of the electronic device according to various embodiments of the present invention are combined to form an entity, which may equally perform the functions of corresponding elements before being combined.

The term “module” used in the present disclosure may mean a unit including one of hardware, software and firmware or a combination of two or more thereof, for example. The “module” may be interchangeably used with the term “unit”, “logic”, “logical block”, “component”, or “circuit”, for example. The “module” may be an elementary unit of or a portion of an integral component. The “module” may also be an elementary unit for performing one or more functions or a portion of the elementary unit. The “module” may be implemented mechanically or electronically. For example, the “module” according to according to various embodiments of the present invention may include at least one of an application-specific integrated circuit (ASIC) chip, a field-programmable gate array (FPGA) and a programmable-logic device performing some operations that have been known or will be developed.

According to various embodiments, at least some of devices (such as modules or their functions) or methods (such as operations) according to the present invention may be implemented as commands stored in a computer-readable storage medium in the form of a programming module, for example. When the command is executed by one or more processors (such as a processor 120), the one or more processors may perform a function corresponding to the command. The computer readable storage medium may be the memory 130, for example. At least a portion of the programming module may be implemented (e.g., performed) by e.g., the processor 120. At least a portion of the programming module may include e.g., a module, a program, a routine, a set of instructions or a process for executing one or more functions.

The computer readable recording medium may include a magnetic medium such as a hard disk, a floppy disk and a magnetic tape, an optical medium such as a compact disk read only memory (CD-ROM) and a digital versatile disc (DVD), a magneto-optical medium such as a floptical disk, and a hardware device that is especially configured to store and execute a program command (such as a programming module), such as a read only memory (ROM), a random access memory (RAM), and a flash memory. Also, the program command may include a machine code made by a compiler as well as a high-level language code that may be executed by a computer by using an interpreter. The above-described hardware device may be configured to operate by one or more software modules to execute the operations of the present invention and vice versa.

A module or programming module according to various embodiments of the present invention may include at least one of the above-described elements and some elements may be left out or other elements may be further included. Operations executed by a module, programming module or another element according to various embodiments of the present invention may be executed by using a sequential, parallel, repetitive or heuristic method. Also, the orders in which some operations are performed may vary, some operations may be left out or further operations may be added.

According to various embodiments, the present invention relates to a storage medium storing commands, wherein the commands are set to allow least one processor to perform at least one operation when being executed by at least one processor, the at least one operation including the operations of obtaining scale ratio information on an original image, obtaining coefficient to be applied to data conversion and scaling of the original image based on the ratio information, and applying the coefficient information to at least some data of the original image to obtain image processed data corresponding to the scale ratio.

According to the image processing method and the electronic device supporting the same according to various embodiments as described above, various embodiments may maintain a certain operation speed and provide image scale data having higher quality than in a previous typical image processing technique.

Also, various embodiments may provide a seamless, stable image display service based on a relatively high operation speed.

Also, various embodiments may provide image scale data having various qualities which a user desires.

Embodiments disclosed in the specification and the drawings only present specific examples to describe technical detail by way of example and are not intended to limit the scope of the present invention. Various modifications can be made to the embodiments presented herein without departing from the scope of the invention.

According to the image processing method and the electronic device supporting the same, various embodiments may comprise a first operation (e.g., obtaining a transformation matrix for substantially simultaneously performing a DCT transformation and a Scailing of an image) and a second operation (e.g., applying the transformation matrix to an image transformation). According to various embodiments as described above, the present invention may process a transformation and a resizing of an image by using one matrix multiplication. Even if, using the one matrix multiplication, the present invention may provide a specific processing time and a specific image quality to satisfy a specific condition. Furthermore, the present invention may process a downsizing of an image even if the scailing ratio is not an integer unit.

What is claimed is:

1. A method of processing an image, the method comprising:
obtaining a scale ratio information for an original image;
obtaining coefficient information based on the scale ratio;
applying data conversion and scaling of the original image based on using the coefficient information to at least some of the original image; and
generating image processed data corresponding to the scale ratio.

2. The method according to claim 1, wherein obtaining the coefficient information comprises detecting coefficient information mapped with size information for the original image and the scale ratio in a coefficient table.

3. The method according to claim 1, wherein obtaining the coefficient information comprises at least one of:
obtaining a zero-padded partial image based on size information and the scale ratio information for a specific frame of the original image;
obtaining at least one identity matrix according to correspondence between the zero-padded partial image and a partial image of the original image; or

4. The method according to claim 3, further comprising storing the coefficient information mapped to the size information and the scale ratio information on the original image.

5. The method according to claim 1, wherein generating the image processed data comprises dividing the original image into blocks having a certain determined size, and applying the coefficient information to at least one of the blocks.

6. The method according to claim 5, wherein generating the image processed data comprises:
performing parallel processing on partial images of the original image in units of blocks.

7. The method according to claim 1, wherein obtaining the coefficient information comprises converting original image data into a frequency domain comprising low frequency components, and obtaining coefficient information set to select a value disposed on the low-frequency components from the frequency domain obtained through conversion, thereby resulting in frequency domain image processed data.

8. The method according to claim 7, further comprising inversely converting the frequency domain image processed data from the frequency domain into a pixel domain.

9. The method of claim 1, wherein applying data conversion and scaling are performed together.

10. An electronic device comprising:
a data processing module configured to check scale ratio information for an original image and to generate image processed data corresponding to the scale ratio by applying coefficient information based on the scale ratio information during data conversion and scaling of the original image, to at least some data of the original image; and
at least one storage module configured to store the original image, a camera configured to collect the original image, and a communication interface configured to receive the original image.

11. The electronic device according to claim 10, wherein the storage module is configured to store a coefficient table comprising coefficient information matching with size information from the original image and the scale ratio information.

12. The electronic device according to claim 11, wherein the data processing module is configured to obtain a zero-padded partial image based on size information for a specific frame of the original image and the scale ratio information, and obtain at least one identity matrix as the coefficient information according to correspondence between the zero-padded partial image and a partial image of the original image.

13. The electronic device according to claim 12, wherein the data processing module is configured to store the coefficient information mapped to the size information and the scale ratio information for the original image in the storage module.

14. The electronic device according to claim 12, wherein the data processing module is configured to divide the original image into blocks having a certain determined size and determine a size of a region to be zero-padded based on a size of the block and the scale ratio information.

15. The electronic device according to claim 12, wherein the data processing module is configured to divide the original image into blocks having a certain determined size and apply the coefficient information to at least one of the blocks.

16. The electronic device according to claim 10, wherein the data processing module divides the original image into block comprising and performs parallel processing on the blocks of the original image.

17. The electronic device of claim 10, wherein the data processing module is configured to perform data conversion and scaling of the original image together.

18. The electronic device according to claim 10, wherein the data processing module is configured to convert the original image data into a frequency domain and obtain coefficient information set to select a value disposed on a low-frequency domain from the frequency domain obtained through conversion, thereby resulting in frequency domain image processed data.

19. The electronic device according to claim 10, wherein the data processing module is configured to inversely convert the frequency domain image processed data from the frequency domain into a pixel domain.

20. A non-transitory machine-readable medium storing a plurality of commands, wherein the plurality of commands, when being executed by at least one processor, cause the at least one processor to:
obtain scale ratio information for an original image;
obtain coefficient information based on the scale ratio information;
apply data conversion and scale of the original image using the coefficient information; and
obtain image processed data corresponding to the scale ratio based on applying the coefficient information to at least some data of the original image.
